(19) United States
(12) Patent Application Publication
(10) Pub. No.: US 2008/0131723 A1
(43) Pub. Date: Jun. 5, 2008

(54) Braze System With Matched Coefficients Of Thermal Expansion

(75) Inventors: Michael C. Tucker, Oakland, CA (US); Craig P. Jacobson, Moraga, CA (US); Lutgard C. Jonghe, Lafayette, CA (US)

Correspondence Address: BEYER WEAVER LLP, P.O. BOX 70250, OAKLAND, CA, 94612-0250, US

(73) Assignee: The Regents Of The University Of California, Oakland, CA (US)

(21) Appl. No.: 11/791,269

(22) PCT Filed: Nov. 23, 2005
(86) PCT No.: PCT/US05/42572

§ 371 Date: Jan. 23, 2008

Related U.S. Application Data
(60) Provisional application No. 60/632,014, filed on Nov. 30, 2004.

(51) Int. Cl. B32B 18/00; C09K 3/00; B23K 1/00; B23K 1/20

(52) U.S. Cl. 428/623; 252/182.33; 428/630; 228/101; 228/121; 228/122.1; 228/176; 228/208; 228/249

(57) ABSTRACT

A CTE modified braze composition that can be utilized to manufacture a strong, gastight joint where at least one of the joining members comprises a ceramic (e.g., a ceramic or a cermet). The braze composition is formulated so as to reduce the thermal stress that results from the mismatch of thermal expansion coefficients between a ceramic joining member and the braze or other joining members. The braze composition comprises a braze alloy in powder, paste or bulk form mixed with one or more particulate or fibrous fillers that exhibit a low (i.e., no more than 6 ppm/K) or negative coefficient of thermal expansion. The braze composition can be used to join members, at least one of which comprises ceramic, and to a composite member produced by joining the two or more members.

### CROSS-REFERENCE TO RELATED APPLICATIONS

This application claims priority to U.S. Provisional Patent Application No. 60/632,014 filed Nov. 30, 2004, entitled BRAZE SYSTEM WITH MATCHED COEFFICIENTS OF THERMAL EXPANSION.

### STATEMENT OF GOVERNMENT SUPPORT

This invention was made with government support under Contract DE-AC02-05CH11231 awarded by the United States Department of Energy to The Regents of the University of California for the management and operation of the Lawrence Berkeley National Laboratory. The government has certain rights in this invention.

### FIELD OF THE INVENTION

The present invention relates to a braze composition reduced in thermal expansion coefficient by the addition of particulate or fibrous filler(s), to the use of this composition, and to a composite member produced by joining two or more ceramic or ceramic and metal members using the braze composition.

### BACKGROUND

Brazing is widely used to join materials by means of a brazing material that melts upon heating and reacts with the surface of the materials to be joined, creating a bond upon cooling and solidification of the braze material. A suitable braze material wets the surfaces of the materials to be joined and allows them to be joined without them being physically changed. To accomplish this, braze materials generally melt at a low temperature relative to the melting points of the materials being joined. The heating and cooling are usually, although not necessarily, carried out in vacuum or inert atmosphere. Braze materials are often based on metals such as Ag, Au, Cu, Ni, Ti, Pd, Pt, Cr, and alloys thereof. Braze base materials can also include small fractions of a wide variety of other elements that are added to tune various properties of the resulting alloy. Brazing can be used effectively to join similar or dissimilar materials, i.e., metals to metals, ceramics to ceramics, and metals to ceramics. Various types of metal to ceramic joints are used in the production of light bulbs, golf clubs, furnaces, semiconductor process chambers, thermal barrier coatings, fuel cells and other electrochemical devices, scientific equipment, etc.

In the case of brazing to ceramics, it is usually necessary to treat the surface of the ceramic so that a strong bond between the ceramic and braze material is achieved. This can be accomplished several ways, including plating a metal film onto the ceramic member before the braze operation, or including an element in the braze alloy that reacts with the ceramic surface during the braze operation. The reactive element is often titanium, hafnium, vanadium, niobium or zirconium. The reactive element may be included, for example, as a cladding layer on a braze filler or as an integral part of a braze alloy.

It is often the case that the coefficient of thermal expansion (CTE) differs substantially for the braze material and the members to be joined. In the case of a ceramic or other brittle joining member, this thermal expansion mismatch can lead to sufficient stress so as to cause cracking in the vicinity of the braze/brittle joining member interface upon cooling after the braze operation or upon thermal excursions during use of the joint. Such cracking can be detrimental to the desired characteristics of the joint, such as joint strength, lifetime and gas-tightness. Cracking can develop if there is mismatch between the coefficients of thermal expansion of the braze alloy and joining members, or between the joining members themselves.

A braze material with a particulate filler that reduces thermal stress has been proposed. For example, Makino et al., (U.S. Pat. No. 6,390,354 and U.S. Pat. No. 6,742,700) disclose an alumnina-filled braze with a CTE matched well enough to that of alumina to avoid cracks in an alumina joining member. However, the surface of the ceramic particles requires metal-plating to enhance wetting with the braze material, and the particulate alumina filler fills up to 90% of the joint volume, which decreases the electrical conductivity of the joint, negatively impacting joint performance in many applications. In addition, alumina is less easily fractured than many other ceramics, such as YSZ, and tests indicate that an alumina-filled braze material is inadequate to effectively join to YSZ without cracking.

Thus, there exists a need for improved brazing compositions that can provide a strong, gas-tight joint when materials that are subject to cracking, i.e. ceramics, are used as a joining member.

### SUMMARY OF THE INVENTION

In one aspect, the present invention relates to a composite braze composition that can be utilized to manufacture a strong, gas-tight joint where at least one of the joining members comprises a ceramic (e.g., is a ceramic or a cermet). The braze composition is formulated so as to reduce the thermal stress that results from the mismatch of thermal expansion coefficients between a ceramic joining member and the braze or other joining members. The braze composition comprises a braze alloy in powder, paste or bulk form mixed with one or more particulate or fibrous fillers that exhibit a low (i.e., no more than 6×10⁻⁶/K) or negative coefficient of thermal expansion. The use of this braze composition to join members, at least one of which comprises ceramic, and to a composite member produced by joining two or more members at least one of which comprises a ceramic using the braze composition are also provided.

In specific embodiments, the braze material is configured to match the CTE of at least one ceramic-containing member to be joined having a CTE between about 8×10⁻⁶/K and 15×10⁻⁶/K, or at least 10×10⁻⁶/K, for example the ceramic YSZ which has a CTE of 10.5×10⁻⁶/K. Here coefficient of thermal expansion (CTE) refers to the linear thermal expansion coefficient, which is the fractional change in length of a bar per degree of temperature change. It is typically measured in parts per million per Kelvin degree (10⁻⁶/K or ppm/K). By “match” it is meant that the CTE of the braze material and the ceramic-containing member (e.g., ceramic or cermet) are close enough that a strong joint may be formed between the two and the ceramic-containing member is not cracked as a result of the brazing operation. A braze material in accordance with the present invention typically has a CTE differing by no more than about 50% of the CTE of the ceramic-containing material to be joined and preferably within 20%, within 10%, or within 5% of the material to be joined. Thus, in specific embodiments, a suitable braze material should have a CTE between about 8 ppm/K and 15 ppm/K, for example about 10 ppm/K or about 12 ppm/K. In various embodiments of the present invention, the braze material will also have structural stability up to about 900° C.

Preferred braze materials also generally contain at least one reactive element, selected from the group including but not limited to titanium, hafnium, vanadium, niobium and zirconium. The reactive element reacts with the surface of ceramic materials, thereby promoting wetting and bonding of the braze material to the ceramic. Thus a strong braze/ceramic bond can be produced without metallizing a ceramic joining member prior to brazing.

The braze filler material is selected from the group of low (e.g., having a CTE of no more than 6×ppm/K) or negative thermal expansion materials. The filler materials are generally oxygen-containing species. In many embodiments, the amount of filler in the braze material should be kept as low as possible so as not to adversely impact desirable properties of the braze material. For example, electronic conductivity is desired in a braze in a fuel cell joint, such as described below. Accordingly, the volume fraction of filler should be less than 50%, or less than 30%, for example about 20-30%. For very low (e.g., 0 or negative) CTE fillers, the volume fraction of filler needed to achieve a low composite CTE of about 8 ppm/K to 15 ppm/K may be less than 10%.

In one aspect, the invention relates to a brazing composition including a bulk material and a CTE reducing filler. The bulk braze material may be Ag, Au, Cu, Ni, Ti, Pd, Pt, Cr, or, typically, alloys thereof. Ag or Ni metals or alloys are particularly preferred in many applications. The CTE of the filler is no more than 6×10⁻⁶/K. The CTE of the braze composition is generally between about 8×10⁻⁶/K and 15×10⁻⁶/K. A reactive element material that facilitates wetting of the braze composition to a ceramic joining member so that pre-treating of the ceramic is not needed is also included in preferred embodiments.

In other aspects, the braze composition may be used to join ceramics or cermets to metal, ceramic, cermet, glass-ceramic or other materials. In particular, the invention is applicable to joining members composed of ceramics with CTEs greater than 8 ppm/K, or at least 10 ppm/K, for example between about 8 ppm/K and 12 ppm/K. In specific embodiments, a joined ceramic or cermet may be ionically conductive. For example, YSZ is an ionically conductive ceramic with a CTE of 10.5 ppm/K. In a particular embodiment, YSZ is joined to metal by a braze in accordance with the present invention.

### BRIEF DESCRIPTION OF THE DRAWINGS

FIG. 1 illustrates a particular implementation of the invention where the CTE modified braze composition is used to join ceramic and metal members in an electrochemical cell.

FIG. 2 illustrates an implementation of the CTE modified braze composition, composite and method the invention for sealing a solid oxide fuel cell.

FIGS. 3A-C illustrate optical microscopic cross sections of braze joints that include various amounts of low-CTE filler particles in CTE modified braze compositions (3B-C) in accordance with the present invention.

FIGS. 4A-B illustrate optical microscopic cross sections of CTE modified braze/substrate interfaces in accordance with the present invention after thermal cycling of YSZ and Ni-YSZ-containing composites.

### DESCRIPTION OF THE INVENTION

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the scope of the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

The present invention was developed in the context of sealing solid oxide fuel cells, and is primarily described in that context in the present application. However, it should be understood that the invention is not limited to this context, but instead may be applied wherever brazing materials are used. The invention is particularly applicable in joints involving at least one brittle (low CTE) material, such as ceramic, e.g., YSZ, or cermet, e.g., Ni-YSZ.

The requirements for the braze material that joins ceramic-containing and/or metal parts in a solid oxide fuel cell are that it (i) wets and bonds to the joining members, (ii) provides a crack-free joint after brazing and during use, (iii) provides a joint with no interconnected porosity, (iv) is stable in fuel and/or oxidizing atmosphere, (v) does not contain entities that could contaminate the other materials of the fuel cell, and in the case of metal-metal joints, (vi) has a high electrical conductivity.

In one aspect, the invention provides a braze metal or alloy mixed with filler particles or fibers of a low or negative coefficient of thermal expansion material. The intention of filling the braze alloy with such particles or fibers is to reduce the total coefficient of thermal expansion of the resulting matrix. This provides for an improved joint when joining members, such as ceramics, that have a coefficient of thermal expansion that is lower than the unfilled braze alloy. Such a filled braze may also reduce the stress associated with joining two different types of members that differ substantially in coefficients of thermal expansion.

Table 1 provides a list of the approximate coefficients of thermal expansion (CTE) for various representative materials:

TABLE 1

| | | CTE |
|---|---|---|
| Material | Function | (ppm/K) |
| Nickel | Joining member | 18.3 |
| 430 Steel | Joining member | 10.4 |
| Alumina ceramic | Joining member | 7.5 |
| YSZ ceramic | Joining member | 10.5 |
| Copper | Braze base | 19.4 |
| Silver | Braze base | 20.6 |
| YSZ | Filler | 10.5 |
| Alumina | Filler | 7.5 |
| Aluminum/magnesium titanate | Filler | 0-5 |
| Zirconium tungstanate | Filler | −11 |

Note: The CTE for the low and negative-CTE materials can vary substantially depending on temperature and particle/grain size. The aluminum-magnesium titanate system for instance should be limited to <100 um particle size to achieve a low CTE. The CTE also varies somewhat according to the Al/Mg ratio (Giordano et al. J. European Ceramic Society 22 (2002) 1811-1822) The zirconium tungstanate system shows a negative CTE at elevated temperatures, but the CTE at room temperature is near 0 ppm/K. (Chu et al. Materials Science and Engineering 95 (1987)303-308)

The above table shows that a wide range of CTEs exist for various materials that can be used to fabricate a brazed joint. Various joining member combinations can be devised, including any combination of ceramic-containing materials (ceramics, cermets) with ceramics, cermets, metals, glasses, glass-ceramics (e.g., MACOR) and composites, e.g., two ceramics with different CTEs, two cermets with different CTEs, metal and ceramic with different CTEs, metal and cermet with different CTEs and metal and ceramic or cermet with similar CTEs. Commercially-available braze materials typically display a CTE between 15-22 ppm/K. This is much higher than the CTE of most ceramic materials, and can lead to cracking of a ceramic joined with traditional braze alloys.

A braze alloy mixed with a filler that has a lower CTE forms a composite material expected to have a CTE between that of the braze and that of the filler. As an estimate of the expected CTE, a linear combination of the CTEs according to volume percent can be used. For example, a 60:40 volume fraction mixture of silver and alumina would have a CTE in the vicinity of (0.60×20.6)+(0.40×7.5)=15.4 ppm/K. Clearly, this is still much larger than the CTE of the ceramic yttrium stabilized zirconia (YSZ). A better mixture for brazing to YSZ is 60:40 silver and aluminum titanate, in accordance with the present invention, which would have a CTE near (0.60×20.6)+(0.4×1)=12.8 ppm/K. Matching the CTE of the braze mixture to the CTE of the joining member most prone to cracking can therefore be accomplished by choosing a combination of filler identity and amount.

Care must be taken because addition of a large amount of filler might adversely affect other aspects of the braze mixture, such as: spreading and ability to bond to the joining members during brazing; and porosity, conductivity, ductility, and stability during operation. Therefore it is desirable to choose a filler that has the lowest CTE, subject to considerations such as stability of the filler at operating conditions, chemical compatibility of the filler with the base braze alloy and joining members, etc., so that the smallest amount possible may be used to achieve the lowered CTE.

The filler and braze alloy can be combined in numerous ways, including but not limited to: mixing the filler with powdered braze alloy and applying the mixture to the joint; filling the joint with filler and then melting the braze alloy into the joint; producing a composite of filler and braze by pre-melting them together, cooling, and applying the resulting composite to the joint; impregnating solid braze alloy with the filler by shearing them together, e.g., in a roll press, extrusion equipment, etc. The braze material can also be preformed as a paste by mixing the dry braze powder with an organic solvent such as terpineol, and applied to the joint location.

In a specific embodiment, the braze alloy contains at least one reactive element, selected from the group including but not limited to titanium, hafnium, vanadium, niobium and zirconium. The reactive element reacts with the surface of ceramic materials, thereby promoting wetting and bonding of the braze material to the ceramic. Thus a strong braze/ceramic bond can be produced without metallizing the ceramic joining member prior to brazing. The reactive element can be incorporated in the braze alloy directly (such as in Ag—Cu—Ti alloy), or can be added as a powder of the reactive element itself or the hydride of the reactive element (such as a mixture of Ag—Cu alloy with Ti or TiH₂ powder). Both routes can be used simultaneously; a mixture of Ag—Cu—Ti alloy and Ti powder has been brazed. It has been found that addition of Ti powder improves wetting of the ceramic surfaces somewhat, and addition of TiH₂ powder greatly improves wetting. This is because Ti will have a native oxide scale on it that inhibits reaction, whereas TiH₂ decomposes during the braze operation to release H₂ and fresh, very reactive Ti. Other reactive elements (hafnium, vanadium, niobium, zirconium, etc.) are also available as powders or powdered hydrides.

The braze filler material is selected from the group of low (e.g., having a CTE of no more than 6 ppm/K) or negative thermal expansion materials. The filler materials are often, but not always, oxygen-containing species. Specific examples are noted below. In many embodiments, the amount of filler in the braze material should be kept as low as possible so as not to adversely impact desirable properties of the braze material. For example, electronic conductivity is desired in a braze in a fuel cell seal, such as described below. Accordingly, the volume fraction of filler should be less than 50%, or less than 30%, for example about 20-30%. For very low (e.g., 0 or negative) CTE fillers, the volume fraction of filler needed to achieve a low composite CTE of about 8 ppm/K to 15 ppm/K may be less than 10%.

Preferably, a reactive element in the braze alloy will react with the surface of the filler material. Thus the filler material need not be treated before brazing in order to assure wetting of the filler material with the braze alloy. Using such materials, a single braze operation will suffice to produce a nonporous composite braze material that is: (i) reduced in coefficient of thermal expansion relative to the parent alloy, and (ii) strongly bonded to the ceramic member. Furthermore the ceramic joining member will not crack in the vicinity of the braze/ceramic interface.

Addition of more reactive element allows the use of a higher volume of filler in the braze joint. For instance, the amount of Al₂TiO₅ filler that can be accommodated by Ticusil (Ag—Cu—Ti) commercial braze while still displaying good wetting to the filler and ceramic joining member is about 25%. By adding TiH₂ to the braze mixture, a joint has been produced with about 30% filler that displayed good wetting.

Several low- and negative-CTE materials are suitable as fillers in accordance with the present invention. A non-exclusive list of some such suitable fillers is provided below:

Low CTE: Al₂TiO₅ and the Al₂TiO₅—MgTi₂O₅ solid solution (Al₂₍₁₋ₓ₎MgₓTi₍₁₊ₓ₎O₅); CTP family (based on CaTi₄P₆O₂₄ with various atomic substitutions possible; and NZP family (based on NaZr₂P₃O₁₂ with various atomic substitutions possible. Specific examples of these families are: Ca₁₋ₓSrₓZr₄P₆O₂₄, Ln_{1/3}Zr₂(PO₄)₃ (Ln=La, Gd). Some substituted examples of are: Si-for-P yielding Na₍₁₊ₓ₎Zr₂P₍₃₋ₓ₎SiₓO₁₂, Sr-for-Ca and Zr-for-Ti yielding Ca₁₋ₓSrₓZr₄P₆O₂₄ and (Mg, Ca, Sr, or Ba)-for-Na in NaZr₂P₃O₁₂.

### Negative CTE: Uniaxially-strained Ni—Ti alloy; Sc₂(WO₄)₃ family; Sc₂(MoO₄)₃ family; ZrW₂O₈; PbTiO₃; TaVO₅; Ta₂O₅—WO₃ solid solution; HfO₂—TiO₂ solid solution; and LiO₂—Al₂O₃—SiO₂ compounds.

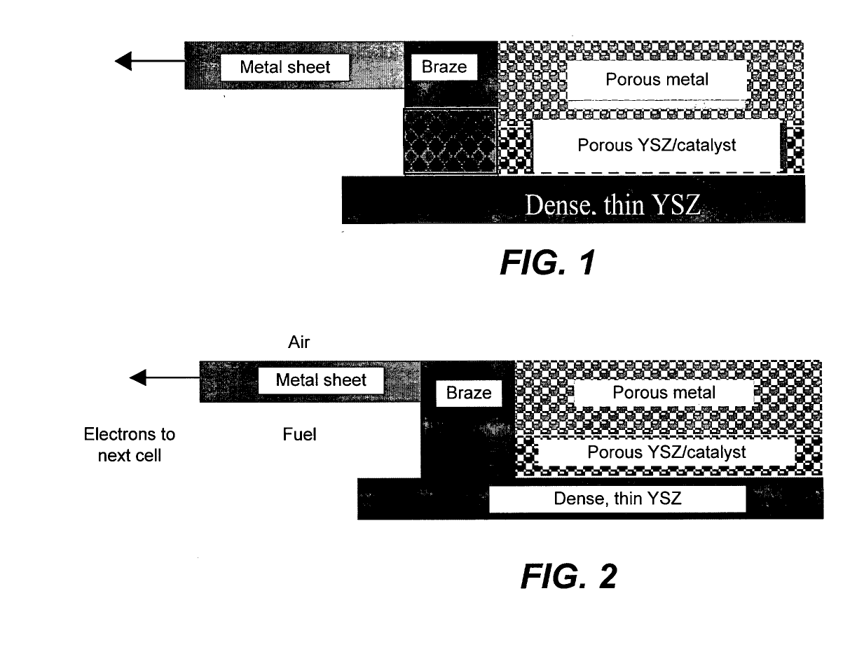

In a composite member produced by joining two or more ceramic-containing or ceramic-containing and metal members using the braze composition, the entire braze joint need not be filled with the low- or negative-CTE material. Only that portion of the braze that is adjacent to a ceramic or cermet joining member or members/in close contact with those joining member(s) needs to have a modified CTE. For example, in one particular implementation of the invention the CTE modified braze composition is used to join ceramic and metal members in an electrochemical cell, for example a solid oxide fuel cell (SOFC). In the schematic of FIG. 1, filler is added to the lower half of the braze joint, where it contacts the ceramic (e.g., yttrium-stabilized zirconia (YSZ)) members. The top part of the braze has less or no filler. This could be an advantage if the filler is expensive, or if addition of the filler reduces the conductivity of the braze. In the illustrated case, it would be desirable to maintain a high-conductivity pathway through the braze between the metal sheet and the porous metal. The filler can be localized to a specific part of the joint, or the concentration of filler can be gradually adjusted throughout the joint, producing a graded structure.

### EXAMPLES

The following examples describe and illustrate aspects and features of specific implementations in accordance with the present invention. It should be understood the following is representative only, and that the invention is not limited by the detail set forth in these examples.

The following braze material (braze/filler mixture) was developed for sealing a solid oxide fuel cell, depicted in FIG. 2.

The braze contacts metal and yttrium-stabilized zirconia ceramic (YSZ), both of which can be porous or dense. The requirements for the braze material are that it (i) wets and bonds to the joining members, yet does not spread across the YSZ surface (ii) provides a crack-free joint after brazing and during use so that the air and fuel do not mix, (iii) provides a joint with no interconnected porosity so that the air and fuel do not mix, (iv) is stable in fuel and oxidizing atmosphere (air), (v) does not contain entities that could contaminate the other materials of the fuel cell, and (vi) has a high electrical conductivity to allow electrons to pass efficiently between the porous metal and the metal sheet.

A crack-free, nonporous, well-bonded joint was obtained between 430 stainless steel and YSZ by using a braze material that comprised a mixture of a Ag—Cu—Ti or Ag—Ti alloy and aluminum/magnesium titanate.

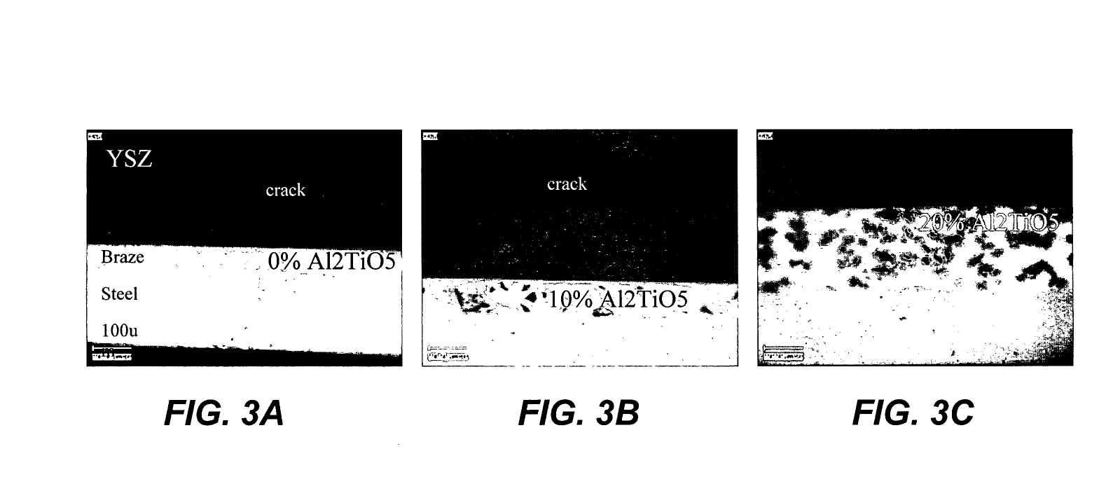

FIGS. 3A-C illustrate cross sections of braze joints that include various amounts of low-CTE filler particles (FIG. 3A shows a braze without filler joining YSZ and steel; FIG. 3B shows a braze with 10% aluminum titanate filler joining YSZ and steel; and FIG. 3C shows a braze with 10% aluminum titanate filler joining YSZ and steel). The CTE modified braze compositions were made by mixing 10-80 μm Al₂TiO₅ (aluminum titanate) filler with the braze metal. The braze metal was 68.8Ag-26.7Cu-4.5Ti alloy powder (Ticusil, a registered trademark of Morgan Advanced Ceramics). The braze joint was produced by sandwiching a physical mixture of the braze metal powder and the filler powder between 430 stainless steel and YSZ sheets. The samples were then placed in a vacuum furnace with 2 psi argon atmosphere and heated to 870° C. for 5 minutes, with a heating and cooling rate of 10° C. per minute to produce the joint.

In all cases the braze material wet the steel and YSZ surfaces, providing a uniform joint with strong interfaces. As shown in the optical microscope images, the YSZ member is clearly cracked in the case of 0% or 10% Al₂TiO₅ filler. The joint with 20% Al₂TiO₅ is crack-free. It is concluded that the addition of this amount of filler lowered the braze CTE towards that of YSZ sufficiently to avoid excessive residual stress in the joint after brazing. Note also that the joints do not contain any pore space.

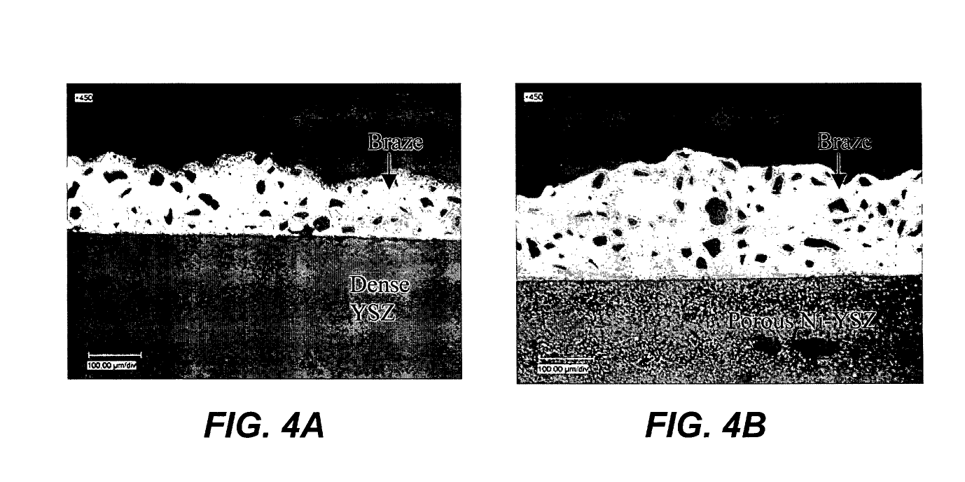

In another example, Ticusil filled with 25 vol % Al₂TiO₅ was brazed onto the surface of dense YSZ and porous Ni-YSZ substrates. After brazing, the samples were thermally cycled. The YSZ sample was cycled very rapidly between 100-700° C. at about 400° C./min. The Ni-YSZ sample was cycled between 350-700° C. at 10° C./min. FIGS. 4A-B illustrate optical microscopic cross section images of the braze/substrate interface after thermal cycling. There are no cracks in the substrate, and no delamination at the braze/substrate interface is detected. This indicates that the addition of this amount of filler lowered the braze CTE towards that of YSZ and Ni-YSZ sufficiently to avoid damaging levels of stress during thermal cycling.

It is well known that Ti-containing braze alloys are reactive towards ceramics, Such as YSZ. This means that the YSZ does not need to be metallized before brazing; the Ti reacts with the YSZ surface during brazing, thus promoting wetting and bonding of the braze to the YSZ surface. A thin, gray Ti-rich reaction layer is visible at the braze/YSZ interface in the images in the figures discussed above. This reaction layer is important for a good bond. A similar reaction layer exists on the surface of the Al₂TiO₅ particles (black spots in the braze layer). The reaction between the filler Surface and Ti in the braze alloy means that the filler does not need to be metallized before brazing in order to assure wetting and bonding of the braze alloy to the filler surface.

As the amount of filler increases, the thickness of the reaction layer at the YSZ/braze interface decreases. While the invention is not limited by this interpretation, this is believed to be because Ti is being used up in the filler-braze reaction and is therefore not available to react with the YSZ surface. This has important implications. For filler levels of 30% and above, a weak or no bond to the YSZ surface was obtained. This is believed to be because not enough Ti was available to react with the YSZ surface, having been used up on the filler surface. Adding more Ti to the braze metal mixture allows for a higher level of filler to be used while still producing a good bond to the YSZ member. For filler levels of 10% and below, there is excess Ti contained in the joint (more than can react with the YSZ surface). The excess Ti migrates out of the joint along the surface of the YSZ. This is undesirable, as the Ti could migrate to other parts of the fuel cell, where it might interfere with the operation of the cell. Therefore, the Al₂TiO₅ filler not only lowers the CTE of the braze joint, it helps to sequester the excess Ti within the joint. This effect is expected for a wide variety of ceramic filler materials. These results indicate that the amount of reactive element and level of filler must be chosen appropriately in order to avoid weak bonding to the ceramic member or excess reactive element. In the case of Ticusil/Al₂TiO₅, 15-25% Al₂TiO₅ is a suitable range for avoiding these undesired results. Note that the particle size of the filler will affect the amount of reactive element used in coating its surface: smaller particles have more surface area to coat per volume. Therefore particle size can be used to tune the balance between reactive element and filler material. The examples described here used about 10-100 μm (28 μm average) particles.

The low CTE of Al₂TiO₅ allows a sufficient CTE match with the ceramic joining member at relatively low filler loading. Much of the prior art uses filler levels well above 20%. This is an advantage of using Al₂TiO₅, as the low filler level means that the electronic and thermal conductivity of the braze composite will remain high.

Note that as the level of filler increases, the thickness of the resulting joint increases as well. Thinner joints could be produced if less braze composite is used. In some applications, however, the ability to control joint thickness by use of a filler may be advantageous.

### CONCLUSION

Thus, the invention encompasses braze materials with CTEs reduced to match that of a ceramic member to be joined by brazing, such a brazed composite, and the associated brazing method. While the invention is described herein primarily with reference to brazes as seals in solid oxide fuel cells it is not so limited. The CTE modified braze materials and methods of the invention may be used to join members forming composite in a wide range of technical fields; anywhere ceramic, cermet or metal and ceramic/cermet joints are required. Examples include: fuel cells and other electrochemical devices, furnaces, semiconductor process chambers, thermal barrier coatings, scientific equipment, light bulbs, medical implants and golf clubs.

Although the foregoing invention has been described in some detail for purposes of clarity of understanding, it will be apparent that certain changes and modifications may be practiced within the scope of the appended claims. It should be noted that there are many alternative ways of implementing both the process and compositions of the present invention. Accordingly, the present embodiments are to be considered as illustrative and not restrictive, and the invention is not to be limited to the details given herein.

All documents cited herein are incorporated by reference in their entirety and for all purposes.

1. A braze composition, comprising:
a bulk braze metal or alloy material; and
one or more particulate or fibrous braze fillers having a coefficient of thermal expansion of no more than 6 ppm/K.

2. The composition of claim 1, wherein at least one of the one or more braze fillers has a coefficient of thermal expansion of between about 0 and 5 ppm/K.

3. The composition of claim 1, wherein the one or more braze fillers is a titanate.

4. The composition of claim 3, wherein the one or more braze fillers is aluminum titanate.

5. The composition of claim 1, wherein at least one of the one or more braze fillers has a negative coefficient of thermal expansion.

6. The composition of claim 5, wherein the one or more braze fillers is zirconium tungstanate.

7. The composition of claim 1, further comprising a ceramic wetting reactive element.

8. The composition of claim 7, wherein the wetting reactive element is selected from the group consisting of titanium, hafnium, vanadium, niobium and zirconium.

9. The composition of claim 1, wherein the braze composition has CTE between about 8 ppm/K and 15 ppm/K.

10. The composition of claim 1, wherein the bulk braze material is selected from the group consisting of Ag, Au, Cu, Ni, Ti, Pd, Pt, Cr and alloys thereof.

11. The composition of claim 1, wherein the composition is structurally stable up to about 900° C.

12. A composite, comprising:
a first joining member comprising a ceramic;
a braze comprising a braze composition according to claim 1;
a second joining member joined to the first joining member by the braze composition.

13. The composite of claim 12, wherein the first joining member is a ceramic.

14. The composite of claim 12, wherein the first joining member is a cermet.

15. The composite of claim 12, wherein the second joining member is selected from the group consisting of ceramic, cermet, metal and glass-ceramic.

16. The composite of claim 12, wherein the first joining member is a ceramic and the second joining member is a metal.

17. The composite of claim 16, wherein the first joining member is YSZ and the second joining member is a stainless steel.

18. The composite of claim 12, wherein the first joining member is a cermet and the second joining member is a glass-ceramic.

19. The composite of claim 18, wherein the first joining member is Ni-YSZ.

20. The composite of claim 12, wherein only a portion of the braze adjacent to a ceramic or cermet joining member or members has the braze filler.

21. The composite of claim 12, wherein the braze composition has braze filler throughout.

22. The composite of claim 12, wherein the CTE of the braze composition differs by no more than about 50% of the CTE of a ceramic or cermet joining member.

23. The composite of claim 22, wherein the CTE of the braze composition differs by no more than about 20% of the CTE of a ceramic or cermet joining member.

24. The composite of claim 23, wherein the CTE of the braze composition differs by no more than about 10% of the CTE of a ceramic or cermet joining member.

25. The composite of claim 24, wherein the CTE of the braze composition differs by no more than about 5% of the CTE of a ceramic or cermet joining member.

26. A method of making composite, comprising:
providing a first joining member comprising a ceramic and a second joining member;
joining the first and second members by brazing with a braze composition according to claim 1.

27. The method of claim 26, wherein the first joining member is a ceramic.

28. The method of claim 26, wherein the first joining member is a cermet.

29. The method of claim 26, wherein the second joining member is selected from the group consisting of ceramic, cermet, metal and glass-ceramic.

30. The method of claim 26, wherein the first joining member is a ceramic and the second joining member is a metal.

31. The method of claim 30, wherein the first joining member is YSZ and the second joining member is a stainless steel.

32. The method of claim 26, wherein the first joining member is a cermet and the second joining member is a glass-ceramic.

33. The method of claim 32, wherein the first joining member is Ni-YSZ.

34. The method of claim 26, wherein only a portion of the braze adjacent to a ceramic or cermet joining member or members has the braze filler.

35. The method of claim 26, wherein the braze composition has braze filler throughout.

36. The method of claim 26, wherein the CTE of the braze composition differs by no more than about 50% of the CTE of a ceramic or cermet joining member.

37. The method of claim 36, wherein the CTE of the braze composition differs by no more than about 20% of the CTE of a ceramic or cermet joining member.

38. The method of claim 37, wherein the CTE of the braze composition differs by no more than about 10% of the CTE of a ceramic or cermet joining member.

39. The method of claim 38, wherein the CTE of the braze composition differs by no more than about 5% of the CTE of a ceramic or cermet joining member.

40. The method of claim 26, wherein a metal film is plated onto a ceramic joining member prior to the braze operation.

41. The method of claim 26, wherein the bulk braze metal or alloy and braze filler are combined and applied to the joining members by a process selected from one of:
mixing the filler with powdered braze metal or alloy and applying the mixture to the joint;
filling the joint with filler and then melting the braze alloy into the joint;
producing a composite of filler and braze by pre-melting them together, cooling, and applying the resulting composite to the joint;
impregnating solid braze alloy with the filler by shearing them together; and
preforming the braze composition as a paste by mixing the dry bulk braze powder and filler with an organic solvent, and applying the paste to the joint location.
